(19) United States
(12) Patent Application Publication
(10) Pub. No.: US 2026/0045426 A1
(43) Pub. Date: Feb. 12, 2026

(54) DC Contactor

(71) Applicant: Tyco Electronics Technology (SIP) Co., Ltd., Suzhou (CN)

(72) Inventors: Zesheng Jiang, Suzhou (CN); Quarry (Bingfeng) Qu, Suzhou (CN); Kevin (Xujia) Wang, Suzhou (CN)

(73) Assignee: Tyco Electronics Technology (SIP) Co., Ltd., Suzhou (CN)

(21) Appl. No.: 19/294,482

(22) Filed: Aug. 8, 2025

(30) Foreign Application Priority Data
Aug. 8, 2024 (CN) 202421918843.5

(51) Int. Cl. H01H 9/04

(52) U.S. Cl. CPC H01H 9/04

(57) ABSTRACT

A DC contactor includes an insulation shell including an upper shell and a lower shell, a static contact fixed to the upper shell and having a static contact point inside the upper shell, a movable contact movably disposed inside the upper shell and having a movable contact point electrically contacting the static contact point, and a sealing element positioned between and forming a seal between the upper shell and the lower shell.

### CROSS-REFERENCE TO RELATED APPLICATION

This application claims the benefit of the filing date under 35 U.S.C. § 119(a)-(d) of Chinese Patent Application No. 202421918843.5, filed on Aug. 8, 2024.

### FIELD OF THE INVENTION

The present invention relates to a DC contactor.

### BACKGROUND OF THE INVENTION

A direct current (DC) contactor typically includes an upper shell, a lower shell, a static contact, and a movable contact. The upper and lower shells are assembled together. An arc extinguishing chamber is defined in the interior of the upper shell. The static contact is fixed to the upper shell and has a static contact point located in the arc extinguishing chamber of the upper shell. The movable contact is movably set in the arc extinguishing chamber of the upper shell and has a movable contact point suitable for electrical contact with the static contact point.

In order to ensure point contact performance, precious metal layers, such as silver alloy layers, are usually applied on the static and movable contact points. However, there is a gap between the upper and lower shells of existing DC contactors, and external gas can enter the arc extinguishing chamber through the gap between the upper and lower shells. This can cause the silver alloy layer to react with the incoming pollutants (such as gases containing Si and S), which can contaminate the silver alloy layer and reduce the electrical contact performance.

### SUMMARY OF THE INVENTION

A DC contactor includes an insulation shell including an upper shell and a lower shell, a static contact fixed to the upper shell and having a static contact point inside the upper shell, a movable contact movably disposed inside the upper shell and having a movable contact point electrically contacting the static contact point, and a sealing element positioned between and forming a seal between the upper shell and the lower shell.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a DC contactor according to a first embodiment of the present invention when viewed from the bottom;

FIG. 2 shows a cross-sectional view of a DC contactor according to the first embodiment of the present invention;

FIG. 3 shows an illustrative perspective view of the DC contactor according to the first embodiment of the present invention when viewed from the bottom, with the lower shell removed;

FIG. 4 shows a cross-sectional view of a DC contactor according to the first embodiment of the present invention, with the lower shell removed;

FIG. 5 shows an illustrative perspective view of the lower shell of the DC contactor according to the first embodiment of the present invention when viewed from the bottom;

FIG. 6 shows a sectional view of the lower shell of the DC contactor according to the first embodiment of the present invention;

FIG. 7 shows a cross-sectional view of a DC contactor according to a first embodiment of the present invention, which illustrates the sealing glue poured into the insertion slot of the lower shell;

FIG. 8 shows an illustrative perspective view of a DC contactor according to the second embodiment of the present invention when viewed from the bottom;

FIG. 9 shows a cross-sectional view of a DC contactor according to a second embodiment of the present invention;

FIG. 10 shows an illustrative perspective view of the DC contactor according to the second embodiment of the present invention when viewed from the bottom, wherein the lower shell and sealing ring are not shown;

FIG. 11 shows an illustrative perspective view of the lower shell of the DC contactor according to the second embodiment of the present invention when viewed from the bottom;

FIG. 12 shows an illustrative perspective view of a DC contactor according to a third embodiment of the present invention when viewed from the bottom;

FIG. 13 shows a cross-sectional view of a DC contactor according to a third embodiment of the present invention;

FIG. 14 shows an illustrative exploded view of a DC contactor according to a third embodiment of the present invention;

FIG. 15 shows a sectional view of the lower shell of a DC contactor according to a third embodiment of the present invention;

FIG. 16 shows a cross-sectional view of a DC contactor according to a third embodiment of the present invention, wherein the lower shell has not yet been assembled onto the upper shell; and

FIG. 17 shows a cross-sectional view of a DC contactor according to a third embodiment of the present invention, in which the lower shell has been assembled onto the upper shell.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

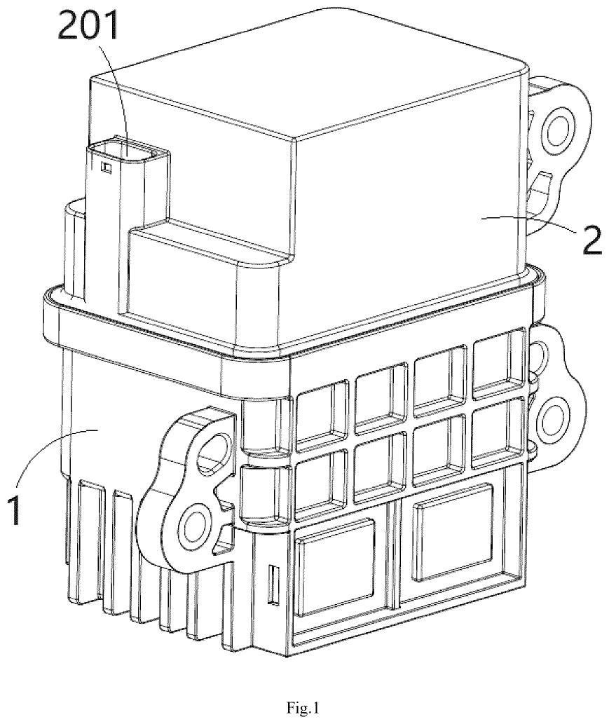

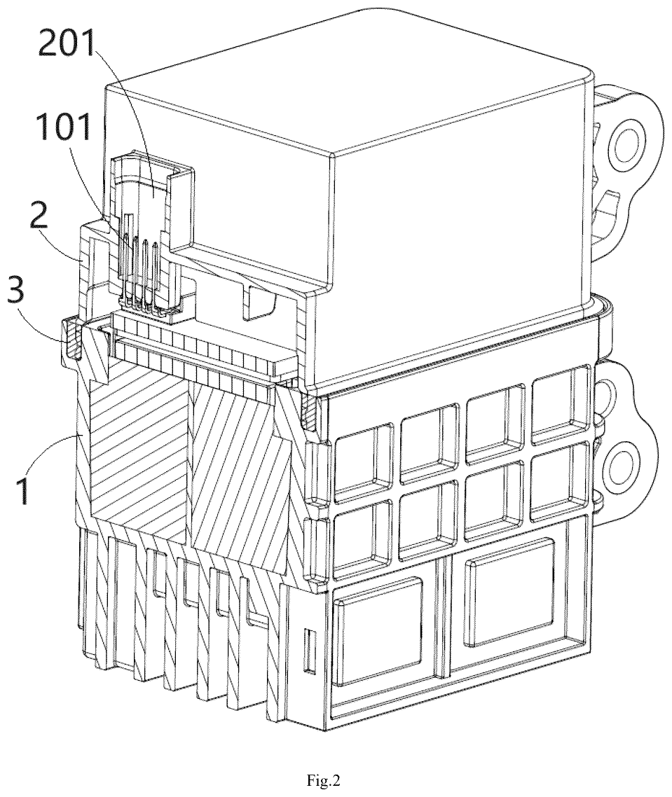

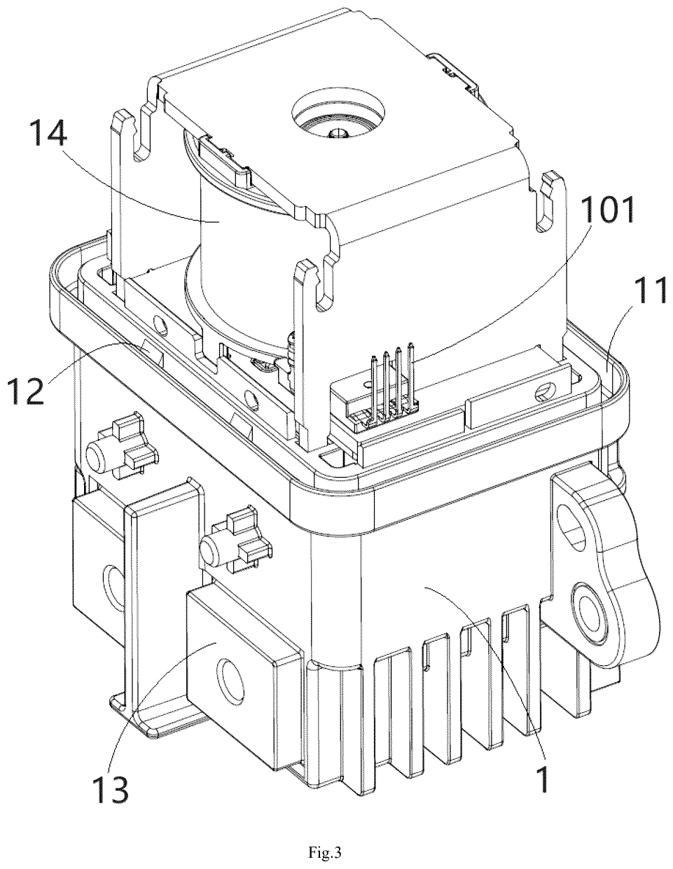

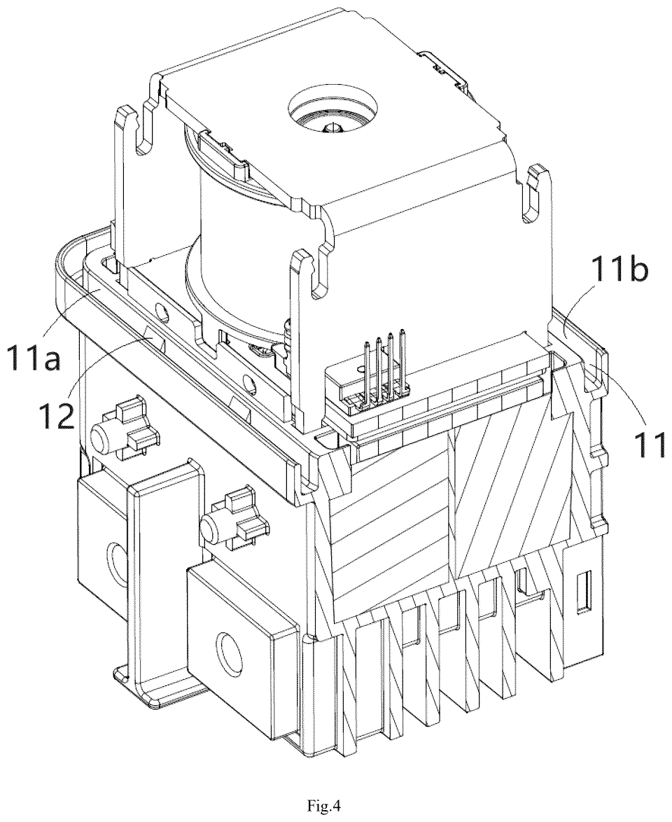

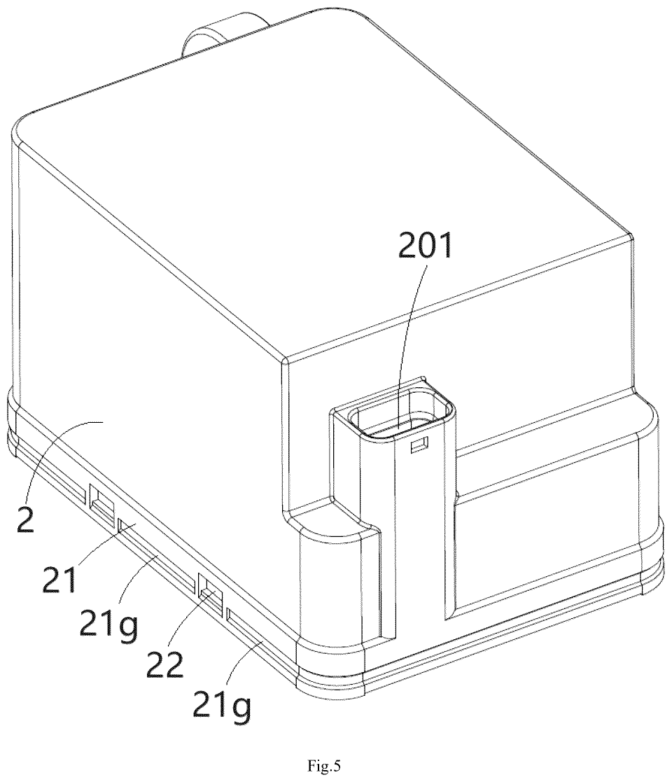

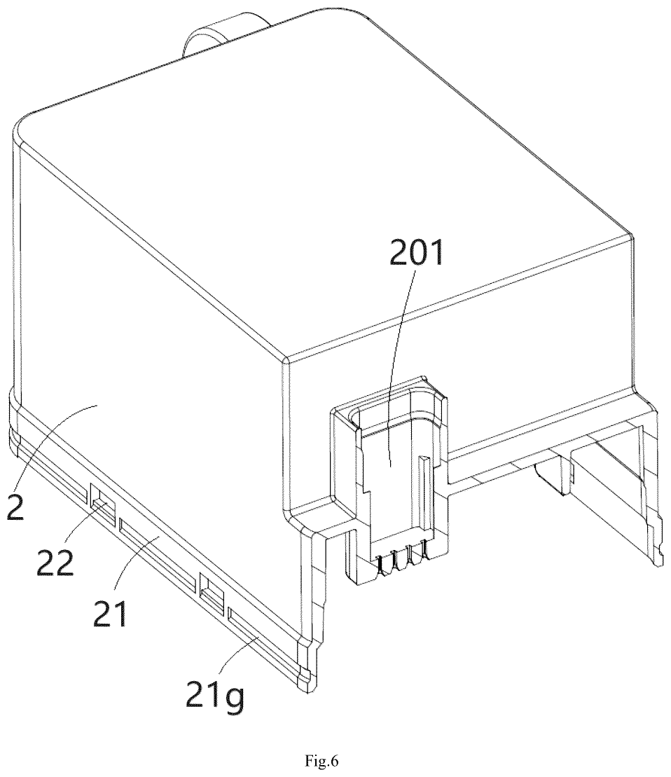

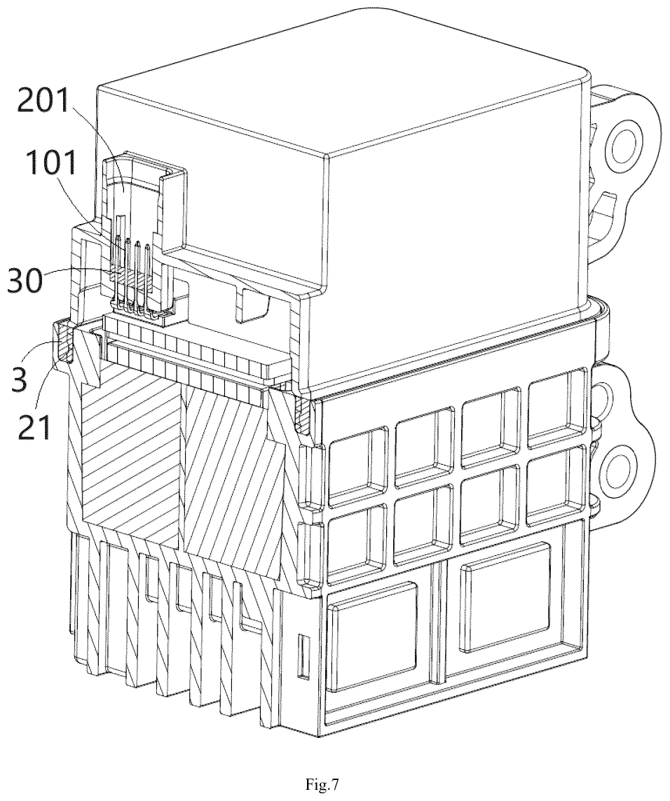

FIGS. 1 to 7 show a DC contactor according to a first embodiment of the present invention. Among them, FIG. 1 shows an illustrative perspective view of the DC contactor according to the first embodiment of the present invention when viewed from the bottom; FIG. 2 shows a cross-sectional view of a DC contactor according to the first embodiment of the present invention; FIG. 3 shows an illustrative perspective view of the DC contactor according to the first embodiment of the present invention when viewed from the bottom, with the lower shell 2 removed; FIG. 4 shows a cross-sectional view of the DC contactor according to the first embodiment of the present invention, with the lower shell 2 removed; FIG. 5 shows an illustrative perspective view of the lower shell 2 of the DC contactor according to the first embodiment of the present invention when viewed from the bottom; FIG. 6 shows a sectional view of the lower shell 2 of the DC contactor according to the first embodiment of the present invention; FIG. 7 shows a cross-sectional view of a DC contactor according to the first embodiment of the present invention, which shows the sealing glue 30 poured into the insertion slot 201 of the lower shell 2.

As shown in FIGS. 1 to 7, in an exemplary embodiment of the present invention, a DC contactor is disclosed. The DC contactor includes an insulation shell, a static contact 13, a movable contact, and a sealing element 3. The insulation shell includes an upper shell 1 and a lower shell 2 that are suitable for assembly together. The static contact 13 is fixed to the upper shell 1 and has a static contact point located inside the upper shell 1, a silver alloy layer is formed on the static contact point. The movable contact is movably set inside the upper shell 1 and has a movable contact point suitable for electrical contact with the static contact point, and a silver alloy layer is formed on the movable contact point. The sealing element 3 is set between the upper shell 1 and the lower shell 2 to achieve sealing between the two.

As shown in FIGS. 3, 4, and 7, in the illustrated embodiment, a ring of sealant groove 11 is formed on the lower end surface of the upper shell 1, and the upper end wall 21 of the lower shell 2 is inserted into the sealant groove 11 of the upper shell 1. The sealing element 3 is formed by the sealant injected into the sealant groove 11.

As shown in FIGS. 3 and 4, in the illustrated embodiment, multiple buckles 12 are formed on the inner side of the sealant groove 11, and multiple snap slots 22 are formed on the upper end wall 21 of the lower shell 2, as shown in FIGS. 5 and 6. The multiple buckles 12 are distributed at intervals in the circumferential direction of the upper shell 1 and are respectively engaged with the multiple snap slots 22 to lock the lower shell 2 to the upper shell 1.

As shown in FIG. 4, in the illustrated embodiment, the sealant groove 11 has a first inner side surface 11a facing the inner side of the upper end wall 21 of the lower shell 2 and a second inner side surface 11b facing the outer side of the upper end wall 21 of the lower shell 2. The buckle 12 is formed on the first inner side surface 11a of the sealant groove 11, the upper end wall 21 of the lower shell 2 is pressed against the first inner side surface 11a of the sealant groove 11.

As shown in FIGS. 3, 4, and 7, in the illustrated embodiment, there is a gap between the second inner side surface 11b of the sealant groove 11 and the upper end wall 21 of the lower shell 2, and the sealant is poured into the gap. A secondary groove 21g, shown in FIGS. 5 and 6, is formed on the second inner side surface 11b of the sealant groove 11 and/or the outer side of the upper end wall 21 of the lower shell 2. The secondary groove 21g is joined with the sealant poured into the gap to increase the bonding force between the sealant and the insulation shell.

As shown in FIG. 3, in the illustrated embodiment, the DC contactor further includes a coil 14, auxiliary contacts, and a plurality of terminals 101. The coil 14 is installed in the lower shell 2. The auxiliary contact is set in the upper shell 1. Multiple terminals 101 are electrically connected to the coil 14 and the auxiliary contacts, respectively. An insertion slot 201, shown in FIGS. 1 and 2, is formed in the lower shell 2, and multiple terminals 101 extend into the insertion slot 201 for mating with multiple mating terminals of a connector inserted into the insertion slot 201. Sealing glue 30, shown in FIG. 7, is poured into the insertion slot 201 to achieve sealing between multiple terminals 101 and lower shell 2. In this way, it can prevent external pollutants from entering the arc extinguishing chamber of the insulation shell through the gap between terminal 101 and lower shell 2. The movable and static contact points are not affected by external pollutant gases, ensuring the electrical contact performance of the movable and static contact points.

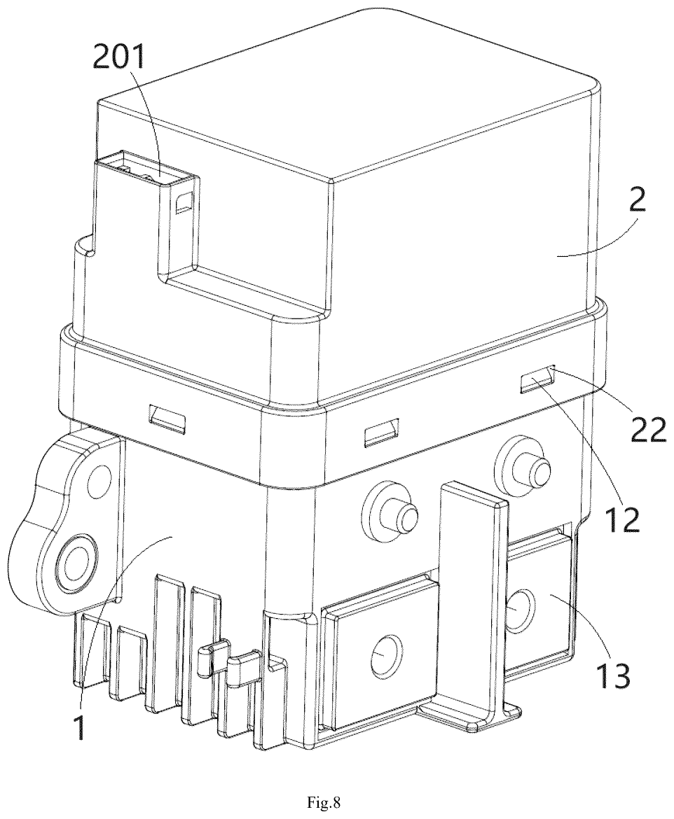

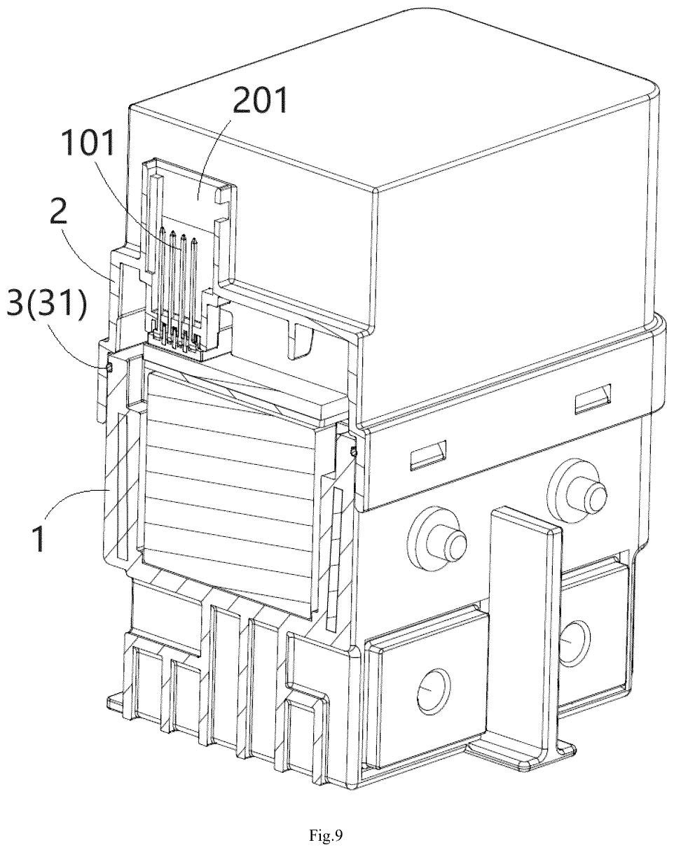

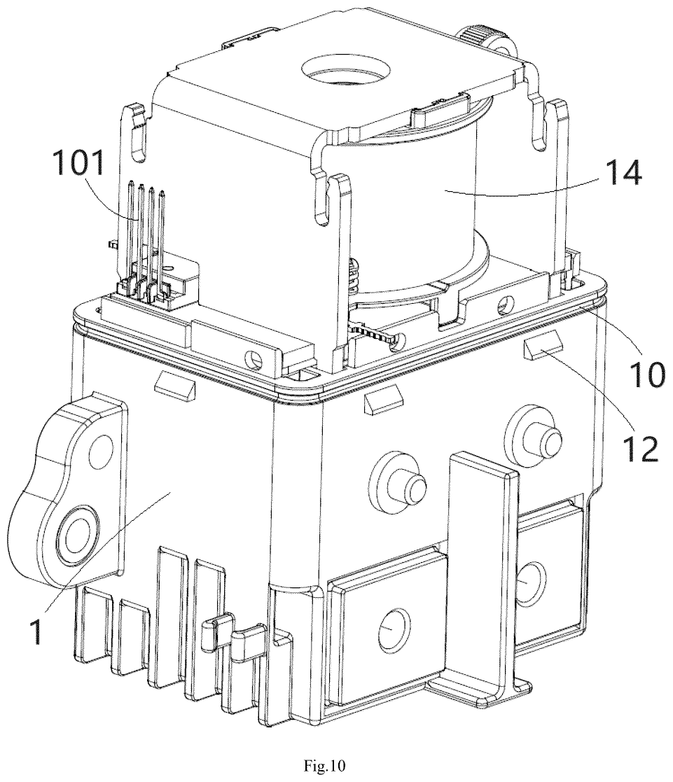

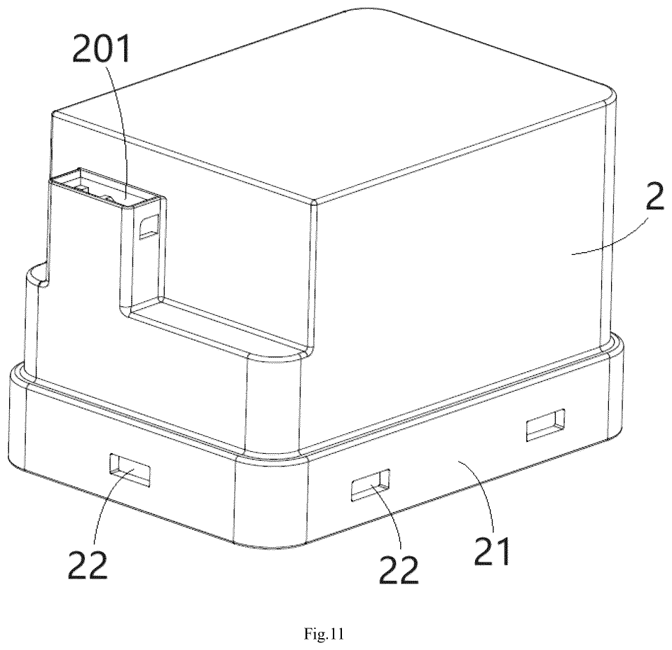

FIGS. 8 to 11 show a DC contactor according to a second embodiment of the present invention. Among them, FIG. 8 shows an illustrative perspective view of the DC contactor according to the second embodiment of the present invention when viewed from the bottom; FIG. 9 shows a cross-sectional view of a DC contactor according to a second embodiment of the present invention; FIG. 10 shows an illustrative perspective view of the DC contactor according to the second embodiment of the present invention when viewed from the bottom, where the lower shell 2 and sealing ring 31 are not shown; FIG. 11 shows an illustrative perspective view of the lower shell 2 of the DC contactor according to the second embodiment of the present invention when viewed from the bottom.

As shown in FIGS. 8 to 11, in an exemplary embodiment of the present invention, a DC contactor is disclosed. The DC contactor includes an insulation shell, a static contact 13, a movable contact, and a sealing element 3. The insulation shell includes an upper shell 1 and a lower shell 2 that are suitable for assembly together. The static contact 13 is fixed to the upper shell 1 and has a static contact point located inside the upper shell 1, a silver alloy layer is formed on the static contact point. The movable contact is set inside the upper shell 1 and has a movable contact point suitable for electrical contact with the static contact point, and a silver alloy layer is formed on the movable contact point. The sealing element 3 is set between the upper shell 1 and the lower shell 2 to achieve sealing between the two.

As shown in FIG. 10, in the illustrated embodiment, a sealing ring installation groove 10 is formed on the outer side of the lower end wall of the upper shell 1, and the sealing element 3 includes a sealing ring 31 installed in the sealing ring installation groove 10, as shown in FIG. 9. The sealing ring 31 is radially compressed between the lower end wall of the upper shell 1 and the upper end wall 21 of the lower shell 2. In the illustrated embodiment, the cross-section of the sealing ring 31 is circular.

As shown in FIGS. 8, 10, and 11, in the illustrated embodiment, multiple buckles 12 are formed on the outer side of the lower end wall of the upper shell 1, and the multiple buckles 12 are located above the sealing ring installation groove 10 and are spaced apart from the sealing ring installation groove 10 by a predetermined distance. Multiple snap slots 22 are formed on the upper end wall 21 of the lower shell 2, and multiple buckles 12 are distributed at intervals in the circumferential direction of the upper shell 1 and are respectively engaged with the multiple snap slots 22 to lock the lower shell 2 to the upper shell 1.

As shown in FIG. 10, in the illustrated embodiment, the DC contactor further includes a coil 14, auxiliary contacts, and multiple terminals 101. The coil 14 is installed in the lower shell 2. The auxiliary contact is set in the upper shell 1. Multiple terminals 101 are electrically connected to the coil 14 and auxiliary contacts, respectively. An insertion slot 201 is formed in the lower shell 2, as shown in FIGS. 8, 9, and 11, and multiple terminals 101 extend into the insertion slot 201 for mating with multiple mating terminals of a connector inserted into the insertion slot 201. Sealing glue 30, shown in FIG. 7, is poured into the insertion slot 201 to achieve sealing between multiple terminals 101 and the lower shell 2. In this way, it can prevent external pollutants from entering the arc extinguishing chamber of the insulation shell through the gap between terminal 101 and lower shell 2.

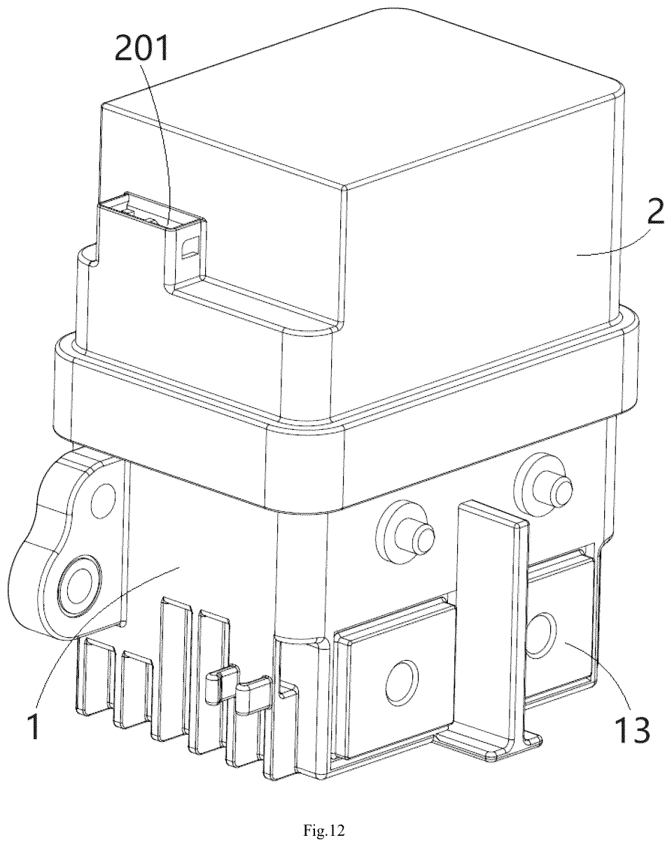

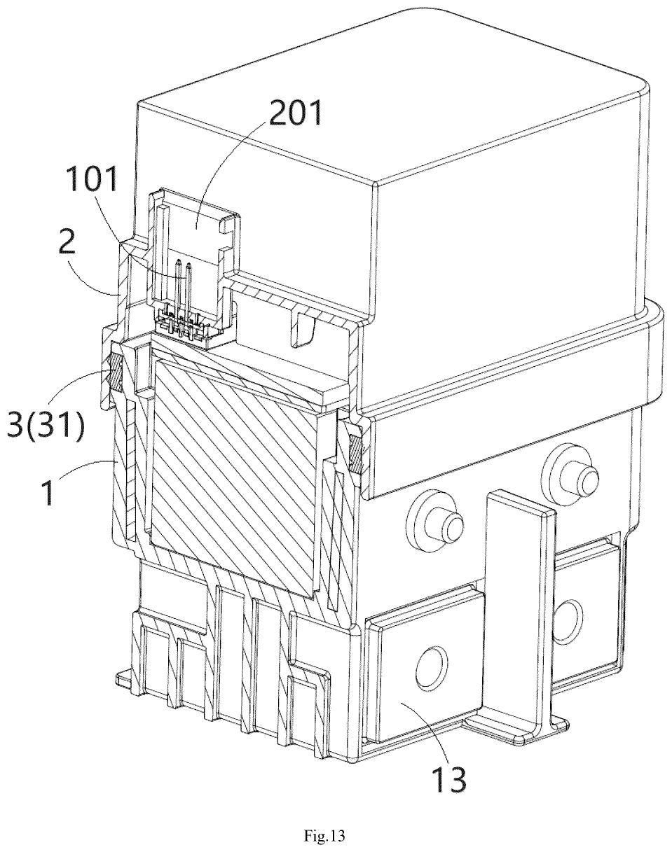

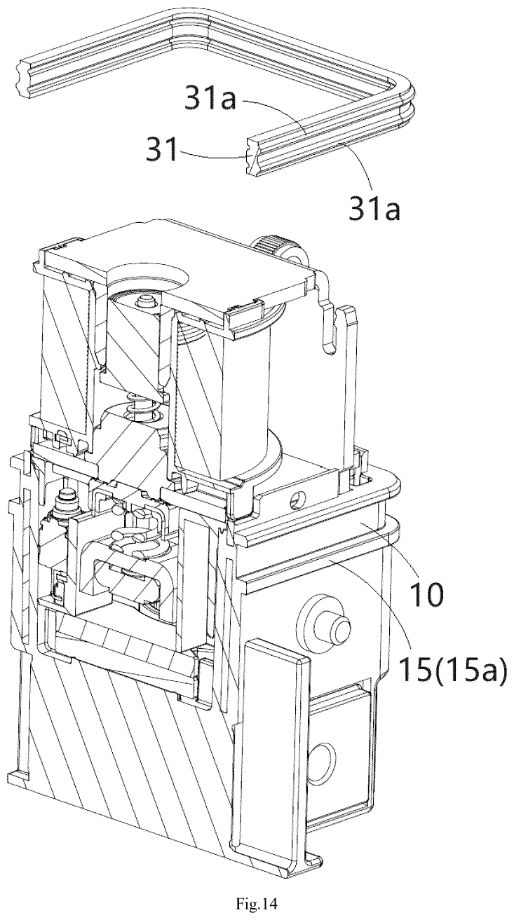

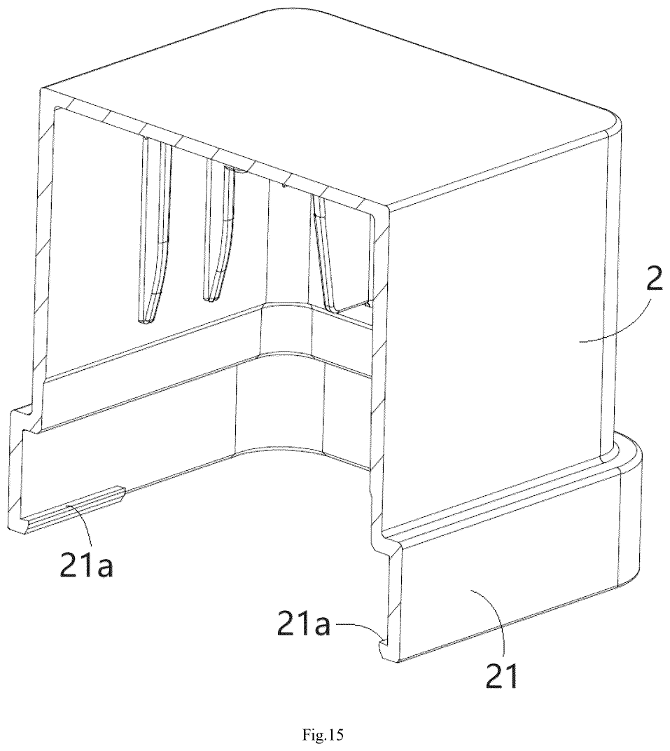

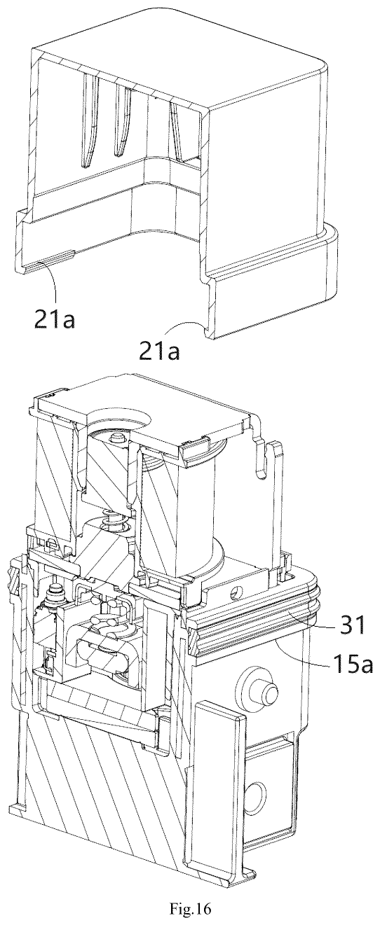

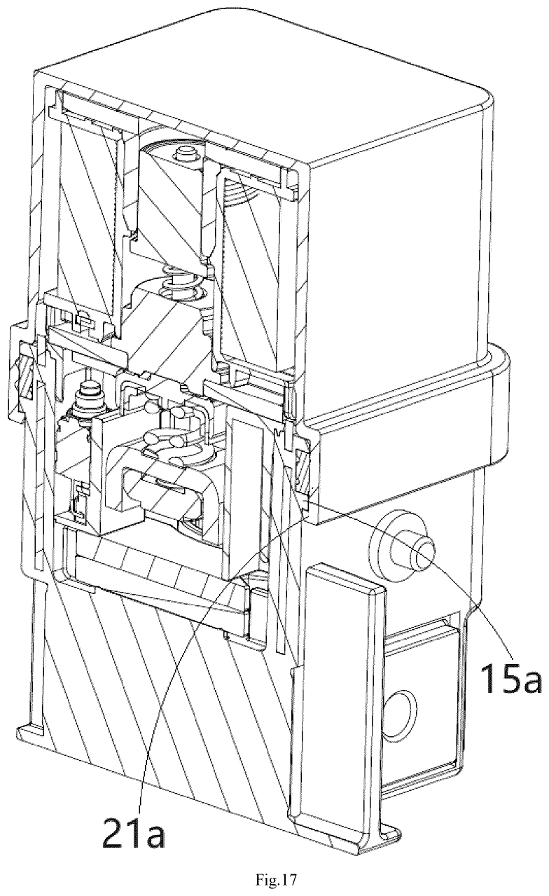

FIGS. 12 to 17 show a DC contactor according to a third embodiment of the present invention. Among them, FIG. 12 shows an illustrative perspective view of the DC contactor according to the third embodiment of the present invention when viewed from the bottom; FIG. 13 shows a cross-sectional view of a DC contactor according to a third embodiment of the present invention; FIG. 14 shows an illustrative exploded view of a DC contactor according to a third embodiment of the present invention; FIG. 15 shows a sectional view of the lower shell 2 of the DC contactor according to the third embodiment of the present invention; FIG. 16 shows a cross-sectional view of a DC contactor according to a third embodiment of the present invention, in which the lower shell 2 has not yet been assembled onto the upper shell 1; FIG. 17 shows a cross-sectional view of a DC contactor according to a third embodiment of the present invention, in which the lower shell 2 has been assembled onto the upper shell 1.

As shown in FIGS. 12 to 17, in an exemplary embodiment of the present invention, a DC contactor is disclosed. The DC contactor includes an insulation shell, a static contact 13, a movable contact, and a sealing element 3. The insulation shell includes an upper shell 1 and a lower shell 2 that are suitable for assembly together. The static contact 13 is fixed to the upper shell 1 and has a static contact point located inside the upper shell 1, a silver alloy layer is formed on the static contact point. The movable contact is set inside the upper shell 1 and has a movable contact point suitable for electrical contact with the static contact point, and a silver alloy layer is formed on the movable contact point. The sealing element 3 is set between the upper shell 1 and the lower shell 2 to achieve sealing between the two.

As shown in FIG. 14, in the illustrated embodiment, a sealing ring installation groove 10 is formed on the outer side of the lower end wall of the upper shell 1, and the sealing element 3 includes a sealing ring 31 installed in the sealing ring installation groove 10, as shown in FIG. 16. The sealing ring 31 is radially compressed between the lower end wall of the upper shell 1 and the upper end wall 21 of the lower shell 2.

As shown in FIG. 14, in the illustrated embodiment, the outer side of the sealing ring 31 has two rings of sealing ribs 31a, which are spaced apart in an axial direction of the sealing ring 31 to achieve double-layer sealing, thereby improving the sealing performance.

As shown in FIG. 14, in the illustrated embodiment, a flange 15 is formed on the outer side of the lower end wall of the upper shell 1, and a sealing ring installation groove 10 is formed on the outer side of the flange 15. In the illustrated embodiment, the flange 15 has a step portion 15a located above the sealing ring installation groove 10, and multiple convex ribs 21a are formed on the inner side of the upper opening of the lower shell 2, as shown in FIG. 15. The multiple convex ribs 21a are engaged with the step portion 15a of the flange 15 to lock the lower shell 2 to the upper shell 1, as shown in FIG. 17.

In the embodiment of FIGS. 12 to 17, the DC contactor further includes a coil 14, auxiliary contacts, and multiple terminals 101. The coil 14 is installed in the lower shell 2. The auxiliary contact is set in the upper shell 1. Multiple terminals 101 are electrically connected to the coil 14 and auxiliary contacts, respectively. An insertion slot 201 is formed on the lower shell 2, and multiple terminals 101 extend into the insertion slot 201, as shown in FIG. 13, for mating with multiple mating terminals of a connector inserted into the insertion slot 201. Sealing glue 30 (see FIG. 7) is poured into insertion slot 201 to achieve sealing between multiple terminals 101 and the lower shell 2. In this way, it can prevent external pollutants from entering the arc extinguishing chamber of the insulation shell through the gap between terminal 101 and lower shell 2.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A DC contactor, comprising:
an insulation shell including an upper shell and a lower shell;
a static contact fixed to the upper shell and having a static contact point inside the upper shell;
a movable contact movably disposed inside the upper shell and having a movable contact point electrically contacting the static contact point; and
a sealing element positioned between and forming a seal between the upper shell and the lower shell.

2. The DC contactor according to claim 1, wherein a sealant groove is formed on a lower end surface of the upper shell.

3. The DC contactor according to claim 2, wherein an upper end wall of the lower shell is inserted into the sealant groove of the upper shell, the sealing element is formed by a sealant filled in the sealant groove.

4. The DC contactor according to claim 3, wherein a plurality of buckles are formed on an inner side of the sealant groove, and a plurality of snap slots are formed on the upper end wall of the lower shell, each of the buckles engages with one of the snap slots to lock the lower shell to the upper shell.

5. The DC contactor according to claim 4, wherein the sealant groove has a first inner side surface facing an inner side of the upper end wall of the lower shell and a second inner side surface facing an outer side of the upper end wall of the lower shell.

6. The DC contactor according to claim 5, wherein the buckles are formed on the first inner side surface of the sealant groove, the upper end wall of the lower shell is pressed against the first inner side surface of the sealant groove.

7. The DC contactor according to claim 6, wherein there is a gap between the second inner side surface of the sealant groove and the upper end wall of the lower shell, the sealant is filled into the gap.

8. The DC contactor according to claim 7, wherein a secondary groove is formed on the second inner side of the sealant groove and/or the outer side of the upper end wall of the lower shell, the secondary groove is joined with the sealant poured into the gap to increase a bonding force between the sealant and the insulation shell.

9. The DC contactor according to claim 1, wherein a sealing ring installation groove is formed on an outer side of a lower end wall of the upper shell, the sealing element includes a sealing ring installed in the sealing ring installation groove.

10. The DC contactor according to claim 9, wherein the sealing ring is radially compressed between the lower end wall of the upper shell and an upper end wall of the lower shell.

11. The DC contactor according to claim 10, wherein a cross-section of the sealing ring is circular.

12. The DC contactor according to claim 11, wherein a plurality of buckles are formed on the outer side of the lower end wall of the upper shell, the buckles are located above the sealing ring installation groove and are spaced apart from the sealing ring installation groove by a predetermined distance.

13. The DC contactor according to claim 12, wherein a plurality of snap slots are formed on the upper end wall of the lower shell, the buckles are distributed at intervals in a circumferential direction of the upper shell and each engage one of the snap slots to lock the lower shell to the upper shell.

14. The DC contactor according to claim 10, wherein an outer side of the sealing ring has a pair of rings of sealing ribs that are spaced apart in an axial direction of the sealing ring.

15. The DC contactor according to claim 14, wherein a flange is formed on the outer side of the lower end wall of the upper shell, the sealing ring installation groove is formed on an outer side of the flange.

16. The DC contactor according to claim 15, wherein the flange has a step portion located above the sealing ring installation groove.

17. The DC contactor according to claim 16, wherein a plurality of convex ribs are formed on an inner side of an upper opening of the lower shell, the convex ribs are engaged with the step portion of the flange to lock the lower shell to the upper shell.

18. The DC contactor according to claim 1, further comprising a coil installed in the lower shell, an auxiliary contact disposed in the upper shell, and a plurality of terminals electrically connected to the coil and the auxiliary contact.

19. The DC contactor according to claim 18, wherein an insertion slot is formed in the lower shell, the terminals extend into the insertion slot to mate with a plurality of mating terminals of a connector inserted into the insertion slot.

20. The DC contactor according to claim 19, wherein a sealing glue is poured into the insertion slot to seal between the terminals and the lower shell.
